(19) United States
(12) Patent Application Publication
(10) Pub. No.: US 2006/0100312 A1
(43) Pub. Date: May 11, 2006

(54) Plastisol ink for textiles

(76) Inventors: Geoffrey Hall, Westgate (GB); Timothy Geofrey Owen, Kingsgate (GB)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/515,247

(22) PCT Filed: May 20, 2003
(86) PCT No.: PCT/GB03/02181

§ 371 Date: Aug. 22, 2005

(30) Foreign Application Priority Data
May 20, 2002 (GB) 0211528.5

(51) Int. Cl. C08L 83/00

(52) U.S. Cl. 523/201

(57) ABSTRACT

The present invention relates to a plastisol ink for textiles and in particular to a screen printable PVC/phthalate-free plastisol textile ink having good storage stability and excellent wet-on-wet printing. characteristics. The plastisol textile ink of the present invention is substantially free of PVC and phthalates and comprises (i) a core-shell acrylic polymer having an acrylic polymer shell with a T_{g} of 90-125° C. and an acrylic polymer core with a lower T_{g} than the shell, (ii) an organic phosphate plasticiser having a viscosity of 60-120 mm²/s, and (iii) a pigment. Any particulate components in the ink have a particle size of 1-80 μm.

The present invention relates to a plastisol ink for textiles and in particular to a screen printable PVC/phthalate-free plastisol textile ink having good storage stability and excellent wet-on-wet printing characteristics.

A plastisol is a dispersion of fine polymer particles in a liquid plasticiser. Other components are added according to necessity, such as pigment, fillers, thixotropic agents, blowing agents, stabiliser etc. Under ambient storage conditions the polymer does not dissolve to any extent in the plasticiser, but on heating to temperatures typically above 100° C. the plastisol composition gels to form a homogenous coalesced mass that retains its gelled form on cooling.

Plastisols are typically used in coatings, such as sealants and cable insulation, and for textiles. Historically, polyvinyl chloride (PVC) has been found to be the most suitable polymer for plastisol compositions. However, PVC has the disadvantage that hydrochloric acid is generated on burning, which can lead to toxic by-products on waste disposal by incineration and consequently is not a desirable material from the point of view of health, safety and environmental protection. The most common plasticisers are alkyl phthalates. However, several low-cost phthalate plasticisers are now thought to act as endocrine disruptors and hence are also becoming undesirable in textile applications.

Thus, there is a requirement for a plastisol ink for screen printing textiles with the same stability, processing and finished print characteristics as a PVC/phthalate plastisol, but without the associated health, safety and environmental problems.

The particular requirements for a plastisol screen printing ink for textiles include being capable of pigmentation, having a stable viscosity, being suitable for storage for several years, being overprintable without pre-drying, i.e. being wet-on-wet printable without offsetting between the prints, and being capable of coalescing at bake temperatures of typically 130-160° C. for 2-5 minutes. The finished print must have acceptable cosmetic features, such as good handle and adhesion to the textile substrate even after washing. The ability to print wet-on-wet is particularly advantageous for a commercial product as it enables the printer to print continuously without having to stop and clean the screen to avoid offsetting the ink.

PVC free plastisols have been proposed for use as screen printing inks, see WO 98/29507. However, the PVC/phthalate-free plastisols described in the prior art are not of comparable quality to commercial PVC-type plastisol inks.

Accordingly, the present invention provides a plastisol textile ink which is substantially free of PVC and phthalates comprising
(i) a core-shell acrylic polymer having an acrylic polymer shell with a T_{g} of 90-125° C. and an acrylic polymer core with a lower T_{g} than the shell,
(ii) an organic phosphate plasticiser having a viscosity of 60-120 mm²/s, and
(iii) a pigment,
   wherein any particulate components in the ink have a particle size of 1-80 μm.

Preferably the acrylic polymer shell has a T_{g} of 100-110° C.

Preferably the core-shell polymer has a particle size of 5-20 μm.

Preferably the organic phosphate plasticiser has a viscosity of 90-110 mm²/s.

Preferably the organic phosphate plasticiser is an aryl phosphate, particularly preferably trixylyl phosphate.

Preferably the ratio of the core-shell polymer (i) to the total plasticiser content (ii) is from 1:1 to 1:3 by weight, particularly preferably from 1:1.2 to 1:2 by weight.

Preferably the plastisol textile ink is suitable for high definition wet-on-wet printing through meshes up to 120 threads per cm PW (plain weave).

Preferably the plastisol textile ink further comprises a thermoplastic polymer, which is preferably a polyester hot melt powder.

Preferably the plastisol textile ink further comprises a blowing agent.

Preferably the plastisol textile ink further comprises a flame retardant.

The present invention also provides the use of an ink as defined above for screen printing.

Plastisols comprising a polymer of alkyl methacrylate and an ester plasticiser are known (see GB 1516510). This type of plastisol has been further improved by using an acrylate having a core-shell construction, where the core material is compatible with the plasticiser and the shell material is incompatible with the plasticiser (see GB 1,581,493). The outer shell is therefore resistant to the plasticiser at ambient temperatures, but may be penetrated by the plasticiser at elevated temperatures, which then allows easy solubilisation due to the compatible inner core, i.e. the core material alone would gel with the plasticisers even at room temperature within a short time, however, in storage, the shell material provides sufficient protection against premature gelling of the core material.

Any acrylate-based core-shell polymer having the required physical properties may be used in the ink of the present invention. Specifically, the shell of the core-shell polymer is incompatible with the plasticiser and has a glass transition temperature (T_{g}) of 90-125° C. The term “incompatible” is understood in the art to mean resistant to the plasticiser at ambient temperatures (20-25° C.). The core has a lower T_{g} than shell and is compatible with the platiciser. Again, “compatible” is a term of the art and indicates that the core is penetratable by the plasticiser at elevated temperatures, i.e. higher than ambient temperatures, to form a gel.

Such core-shell polymers are well known in the art and are commercially available. By way of example, the core-shell polymer may be a core-shell polymer consisting of (a) a core material compatible with the plasticiser and comprising a polymer derived from a monomer or monomer composition comprising (i) 15 to 100% by weight of at least one of C₃₋₂₅ alkyl acrylates and C₂₋₂₅ alkyl methacrylates, and optionally styrene; (ii) 0 to 85% by weight of at least one monomer selected from methyl acrylate, methyl methacrylate and ethyl acrylate; and/or (iii) 0 to 20% by weight of one or more further radically polymerisable monomers; and (b) a shell material which is incompatible with the plasticiser, the shell material comprising a homopolymer of methyl methacrylate or a copolymer containing at least 80% by weight of units of methyl methacrylate and having a glass temperature of 90-125° C., the core material (a) and the shell material (b) being present in a weight ratio of 3:1 to 1:3.

The preparation of core-shell polymers of this type is well-known in the art, see, for example, GB 1,581,493. In one process, the core-shell polymer is prepared by emulsion polymerisation. The monomers forming the core material are polymerised in aqueous emulsion in a first process step. When the monomers of the first step are substantially polymerised, the monomers forming the shell material are added to the emulsion polymer under such conditions that the formation of new particles is avoided. The polymer obtained in the second step is deposited in the form of a shell around the core material. A favourable ratio of shell thickness to core size is obtained if the weight of core material to shell material is 1:3 to 3:1. The dispersions are obtained may be converted into a dry powder by drying in conventional manner.

In the plastisol, the individual. core-shell polymer particles aggregate to form larger particles. These aggregate particles must have a particle size of 1-80 μm, preferably, 5-50 μm, particularly preferably 5-20 μm. Aggregate particle sizes may be determined by optical or physical separation methods. The term “particle size” used herein represents an average particle diameter, i.e. V₅₀.

Any phosphate plasticiser may be used in the present invention provided it has a viscosity of 60-120mm²/s. However, tri(C₁₋₆-substituted phenyl) phosphates are preferred. Particularly preferred phosphates include isopropylated triaryl phosphate, tricresyl phosphate, (phenyl, isopropoxylate phosphate 3/1) and trixylyl phosphate.

The viscosity of the plasticiser is measured at 25° C. using a CAP2000 Cone and Plate viscometer fitted with a no. 4 cone at 100 rpm.

The plastisol is substantially free of PVC and phthalates. The term “substantially free” here means that the amount of PVC is sufficiently low so as not to require removal of hydrochloric acid on incineration and the amount of phthalate is below toxic levels. Preferably PVC is present at less than 1% and phthalate is present at less than 1%.

The pigment must be compatible with the other components in the ink and must not interfere with plastisol formation, but otherwise any pigment is acceptable. A large number of pigments are commercially available and are well known to the skilled person. The pigment must have a particle size of 1-80 μm, preferably, 5-50 μm, particularly preferably 5-20 μm.

The plastisol ink of the present invention should have a viscosity of 1-10 Pas (10-100 poise). When used as an ink, the plastisol ink should preferably have a viscosity of 3-4 Pas (30-40 poise). When used as a base coat, the plastisol ink should preferably have a viscosity of 5-6 Pas (50-60 poise). The viscosity of the plastisol ink may be varied by varying the ratio of core-shell polymer to plasticiser. The ink should also have a wide latitude of cure, i.e. from 110 to 200° C., to form a flexible and durable coating on the garment which is resistant to washing at 60° C. The ink is also capable of being pigmented to give a range of colours from which a Pantone® system can be matched and may be opaque in colour so as to be suitable for use on light or dark substrates.

The plastisol ink of the present invention may also contain optional additives, well known in the art, which would be normally be used to modify PVC/phthalate plastisols to give other decorative effects or the alter the theological properties of the ink.

One example is to generate swelling on curing to produce a “Puff” effect. These additives, known in the art as blowing agents, are typically chemicals which breakdown on heating to give gaseous byproducts, such as Expancel® 461 DU Microsphere (supplied by Expancel), Unicell OH (supplied by OMYA), and Genitron LE (supplied by Acrol) or gas-encapsulated thermoplastic microspheres.

If it is necessary to modify the rheology of the ink, before curing, then non-phosphate and non-phthalate plasticisers may be added to the mixture. Preferably, polymeric plasticisers are blended with the (non-polymeric) organic phosphates. Polymeric plasticisers are well known in the art.

It is also known in the art that textile plastisol inks may be used as thermal transfer media, where the plastisol is printed first onto a carrier sheet, e.g. siliconised paper, and then partially heat hardened. At a later date, the ink layer may be transferred to a textile at a higher temperature in a heated press. To facilitate the use as a transfer medium, additives such as thermoplastic polymers, which are insoluble in the plastisol, may be incorporated by simply dispersing the thermoplastic polymer into the plastisol by a mixing process. Examples of thermoplastic polymers are Schaetti Fix 374 (Polyester Hotmelt powder supplied by Bostik), Griltex 1AP1 and Griltex 2AP1 (Polyamide Hotmelt powders supplied by EMS).

### EXAMPLES

### Examples 1-21

The table below illustrates the importance of selecting the correct combination of T_{g} of the acrylic with the plasticiser to obtain the required properties of compatibility and stability.

The acrylic and plasticiser were made in the proportions of 1:1.5. A commercial plastisol textile, i.e. Texopaque® OP381 (Sericol Ltd) was used as the PVC/phthalate formula type control.

The terms “compatibility” and “stability” used in the table below have the following meanings.

Compatibility: Apply a layer of the acrylic/plasticiser mixture onto a glass plate and heat in an oven at 160° C. for 3 min. Allow to cool and observe the degree of separation of the plasticiser over several days. The separated plasticiser is clearly distinguishable as a clear liquid and is distinct from the more opaque solid plastisol mixture. Good means no migration of the plasticiser after 14 days further at room temperature. Moderate means some separation within 1-14 days. Poor means separation in less than 24 hrs.

Stability: The acrylic/plasticiser mixture is stored in a sealed pot at 40° C. over 4 weeks. There should be no substantial increase in viscosity during this test, which simulates several years storage at ambient temperatures. Good means no gelling after 4 weeks. Moderate means gelled in 1 day-4 weeks. Poor means gelled in less than 24 hrs.

| | | | Plasticiser | | |
|---|---|---|---|---|---|
| | T_{g} of | | Viscosity at | | |
| Example | acrylic | | 25° C. | Plastisol | Plastisol |
| No. | (° C.) | Plasticiser | (mm²/s) | Compatibility | Stability |
| 1* | PVC Control | | | Good | Good |
| 2* | 85 | trixylyl phosphate | 110 | Moderate | Poor |
| 3 | 90 | trixylyl phosphate | 110 | Moderate | Moderate |
| 4 | 95 | trixylyl phosphate | 110 | Moderate | Good |
| 5* | 110 | 2-ethylhexyl | 22 | Good | Poor |
| | | diphenyl | | | |
| | | phosphate | | | |
| 6* | 110 | isodecyl diphenyl | 22 | Good | Poor |
| | | phosphate | | | |
| 7* | 110 | C₁₂-C₁₆ alkyl | 24 | Good | Poor |
| | | diphenyl | | | |
| | | phosphate | | | |
| 8* | 110 | cresyl diphenyl | 31 | Good | Poor |
| | | phosphate | | | |
| 9 | 110 | isopropylated | 60 | Good | Moderate |
| | | triaryl phosphate | | | |
| 10 | 110 | tricresyl | 70 | Good | Moderate |
| | | phosphate | | | |
| 11 | 110 | phenyl, | 93 | Good | Moderate |
| | | isopropoxylate | | | |
| | | phosphate 3/1 | | | |
| 12 | 110 | trixylyl phosphate | 110 | Good | Good |
| 13 | 114 | trixylyl phosphate | 110 | Moderate/Good | Good |
| 14 | 118 | isopropylated | 60 | Good | Moderate |
| | | triaryl phosphate | | | |
| 15 | 118 | tricresyl | 70 | Good | Moderate |
| | | phosphate | | | |
| 16 | 118 | phenyl, | 93 | Moderate/ | Good |
| | | isopropoxylate | | Good | |
| | | phosphate 3/1 | | | |
| 17 | 118 | trixylyl phosphate | 110 | Moderate | Good |
| 18 | 124 | isopropylated | 60 | Good | Moderate |
| | | triaryl phosphate | | | |
| 19 | 124 | tricresyl | 70 | Good | Moderate |
| | | phosphate | | | |
| 20 | 124 | phenyl, | 93 | Good | Moderate/ |
| | | isopropoxylate | | | Good |
| | | phosphate 3/1 | | | |
| 21 | 124 | trixylyl phosphate | 110 | Moderate | Good |

*indicates a comparative example which does not fall within the scope of the present invention.

### Example 22 Example 23

Examples 22 and 23 were prepared using a standard high-speed stirrer to illustrate the importance of particle size of the acrylic resin selected.

| | Example 22 | Example 23 |
|---|---|---|
| Core/shell acrylic particle size 50 μm | 20 | — |
| (T_{g} 110° C.) | | |
| A Core/shell acrylic particle size <20 μm | — | 20 |
| (T_{g} 110° C.) | | |
| Trixylyl phosphate | 45 | 45 |
| Kronos 2190 (Stirrable TiO₂ pigment) | 30 | 30 |

Examples 22 and 23 were printed under production conditions on a textile multicolour screen printing machine. Example 22 allowed wet-on-wet printing. Example 23 also allowed wet-on-wet printing but required less cleaning than Example 22 (required no cleaning even after a thousand prints). Also Example 23 could more easily produce fine detail prints than Example 22.

### Examples 24-26

The following examples illustrate another embodiment of the present invention, where different coloured inks can be satisfactorily printed onto each other wet-on-wet without inter-colour drying.

| | Example 24 | Example 25 | Example 26 |
|---|---|---|---|
| Core/shell acrylic of | 20 | 38 | 36 |
| T_{g} 110° C. | | | |
| (Particle size <20 μm) | | | |
| Trixylyl phosphate | 45 | 60 | 58 |
| TiO₂ pigment | — | 2 | — |
| Carbon black pigment | — | 2 | — |
| CI pigment red PR122 | — | — | 2 |
| Silica | 0.5 | — | — |
| Amine salt of | 0.5 | — | — |
| benzene sulfonic acid | | | |

These samples were printed using an M&R semi-automatic textile printing carousel (Premiere) through silk screens of 120 threads per cm PW onto black cotton interlock. Example 24 was printed down first, followed by a flash cure schedule of 5 seconds at 500° C. (IR medium wavelength output), this was then subsequently overprinted using screens containing the ink of Example 25 followed by the ink of Example 26. These examples were printed wet-on-wet, without any significant picking of the ink when overprinted by subsequent colours. The printed interlock was then removed from the machine and cured at a setting of 400° C. (M&R 2 metre Radicure Drier) on a IR belt drier at a conveyor belt speed of 4 m/minute. The process was repeated using a standard commercial PVC and phthalate ink, i.e. “Texopaque” (Sericol Ltd) plastisols FW755, OP001 and OP165. The resulting decorations made with the invention showed comparable properties of wash resistance, opacity, flexibility and durability as those made with the commercial “Texopaque” (Sericol Ltd) ink. In addition to these properties, the PVC/phthalate-free decoration displayed both a greater resistance to ignition by direct application of a flame and a greater tendency to self-extinguish once alight when subjected to industry standard methods for testing flammability.

The following example demonstrates the use of the invention as an expanding “puff” ink.

### Example 27

| | |
|---|---|
| Core/shell acrylic of T_{g} 110° C. | 25% |
| Trixylyl phosphate | 60% |
| Gas encapsulated thermoplastic microspheres (Expancel | 12% |
| 461 microspheres from Boud Marketing Ltd) | |
| Fumed silica (Cab-o-sil TS530 from Cabot) | 2% |
| Amine salt of benzene sulfonic acid (Rhodacal A4D | 1% |
| from Caldic UK Ltd) | |

The following example demonstrates the use of the invention as a thermal transfer ink.

### Example 28

| | |
|---|---|
| Core/shell acrylic of T_{g} 110° C. | 34% |
| Trixylyl phosphate | 50% |
| Polyester hot melt adhesive of mp 120° C. (Schaetti Fix | 15% |
| 374/0-80 from Bostik Ltd) | |
| Amine salt of benzene sulfonic acid(Rhodacal A4D from | 1% |
| Caldic UK Ltd) | |

The following example demonstrates the use of the present invention with alternate physical printing characteristics using a blend of polymeric and phosphate plasticisers.

### Example 29

| | |
|---|---|
| Core/shell acrylic of T_{g} 110° C. | 46% |
| Trixylyl phosphate | 27% |
| Polymeric plasticiser 3-5 Pas (30-50 poise) at 25° C. | 26% |
| (Lankroflex PLA from Akros Chemicals) | |
| Amine salt of benzene sulfonic acid (Rhodacal A4D | 1% |
| from Caldic UK Ltd) | |

1-14. (canceled)

15. A plastisol textile ink which is substantially free of PVC and phthalates comprising
(i) a core-shell acrylic polymer having an acrylic polymer shell with a T_{g} of 90-125° C. and an acrylic polymer core with a lower T_{g} than the shell,
(ii) an organic phosphate plasticiser having a viscosity of 60-120 mm²/s, and
(iii) a pigment,
Wherein any particulate components in the ink have a particle size of 1-80 μm.

16. A plastisol textile ink as claimed in claim 15, wherein the acrylic polymer shell has a T_{g} of 100-110° C.

17. A plastisol textile ink as claimed in claim 15 wherein the core-shell polymer has a particle size of 5-20 μm.

18. A plastisol textile ink as claimed in claim 1 wherein the organic phosphate plasticiser has a viscosity of 90-110 mm²/s.

19. A plastisol textile ink as claimed in claim 15, wherein the organic phosphate plasticiser is an aryl phosphate.

20. A plastisol textile ink as claimed in claim 19, wherein the aryl phosphate plasticiser is trixylyl phosphate.

21. A plastisol textile ink as claimed in claim 15, wherein the ratio of the core-shell polymer (i) to the total plasticiser content (ii) is from 1:1 to 1:3.

22. A plastisol textile ink as claimed in claim 21, wherein the ratio is from 1:12 to 1:2.

23. A plastisol textile ink as claimed in claim 15 which is suitable for high definition wet-on-wet printing through meshes up to 120 threads per cm PW.

24. A plastisol textile ink as claimed in claim 15, further comprising a thermoplastic polymer.

25. A plastisol textile ink as claimed claim 24, wherein the thermoplastic polymer is a polyester hot melt powder.

26. A plastisol textile ink as claimed in claim 15, further comprising a blowing agent.

27. A plastisol textile ink as claimed in claim 15, further comprising a flame retardant.

28. In a method for screen printing wherein an ink is printed onto a substrate through a screen, the improvement which comprises the ink being the ink of claim 15.

29. In a method for screen printing wherein an ink is printed onto a substrate through a screen, the improvement which comprises the ink being the ink of claim 16.

30. In a method for screen printing wherein an ink is printed onto a substrate through a screen, the improvement which comprises the ink being the ink of claim 17.

31. In a method for screen printing wherein an ink is printed onto a substrate through a screen, the improvement which comprises the ink being the ink of claim 18.

32. In a method for screen printing wherein an ink is printed onto a substrate through a screen, the improvement which comprises the ink being the ink of claim 19.

33. In a method for screen printing wherein an ink is printed onto a substrate through a screen, the improvement which comprises the ink being the ink of claim 20.

34. In a method for screen printing wherein an ink is printed onto a substrate through a screen, the improvement which comprises the ink being the ink of claim 21.
